(19) United States
(12) Patent Application Publication
(10) Pub. No.: US 2008/0077577 A1
(43) Pub. Date: Mar. 27, 2008

(54) Research and Monitoring Tool to Determine the Likelihood of the Public Finding Information Using a Keyword Search

(76) Inventors: Joseph J. Byrne, St. Louis, MO (US); Robert P. Schmidt, St. Louis, MO (US); Jiyan N. Wei, Washington, DC (US); Gerard E. Helbling, St. Louis, MO (US)

Correspondence Address: GRACE J FISHEL, 2200 WEST PORT PLAZA DRIVE, SUITE 202, ST. LOUIS, MO, 63146, US

(21) Appl. No.: 11/859,452

(22) Filed: Sep. 21, 2007

Related U.S. Application Data
(60) Provisional application No. 60/827,134, filed on Sep. 27, 2006.

(51) Int. Cl. G06F 17/30

(52) U.S. Cl. 707/5; 707/E17.108

(57) ABSTRACT

A method and system of ranking information according to the likelihood of its being seen as result of a keyword search on any given issue.

This application claims priority from provisional application Ser. No. 60/827,134 filed Sep. 27, 2006 for “Research and monitoring tool to determine the likelihood of the public finding information using a keyword search.”

### FIELD OF THE INVENTION

The present invention generally relates to any information made available in a keyword searchable form, usually any electronic form but not limited to electronic media. For example, the invention applies to information found at WEB PAGEs by use of a search engine. Please note, this document will use the term “container” as described in the appendix to refer to the chunk of information that is found.

### SUMMARY OF THE INVENTION

In one embodiment, the invention comprises software, processes and algorithms that measure the likelihood that a container (e.g. web sites, web pages, etc.) will be seen (viewed or accessed) by the public. This measure of the likelihood that a container will be seen by the public is referred to as “visibility.” This measure is an attribute of a container. For example, a web page is a container so we will refer to “a web page's visibility.”

In one embodiment, software, processes and algorithms, used separately or in conjunction with the above, measure the likelihood that a search term will yield results that are consistent with the intended meaning of the search term. (For example, searching “Paris Hilton” may not yield results related to accommodations in the capital of France.) This measure is referred to as “relevance.” This measure is an attribute of a search term and referred to as “a search term's relevance.”

In one embodiment, software, processes and algorithms, used separately or in conjunction with the above, measure the degree to which two terms are synonymous. For example, TX is highly synonymous with Texas while Tex is not as highly synonymous with TX. This measure is called “the degree of synonymy.” Synonymy is an attribute of any pair of words and is referred to as “the synonymy of a and b where a and b are words.”

In one embodiment, software, processes and algorithms used separately or in conjunction with the above, measure the public's interest in a particular issue. For example, the public may show a greater concern regarding kitty litter odor as compared to their concern for the risk to pregnancy posed by kitty litter. This measure is referred to as a degree of interest. Interest is an attribute of an issue as in “the public's interest in the issue of cat litter odor.”

In one embodiment, software, processes and algorithms used separately or in conjunction with the above, measure brand awareness. For example, whether the public is as likely to name Colgate over Crest.

In one embodiment, software, processes and algorithms used separately or in conjunction with the above, measure issue conflation. For example, does the public believe that tooth stain is more attributable to tea or to coffee?

In one embodiment, software, processes and algorithms used separately or in conjunction with the above, measure slant. Slant is the bias in information in favor or against a particular position. Slant can be an attribute of any container; for example we can measure slant in a single word, “pro-life” or in an entire web site such as “Greenpeace is slanted in favor of whale survival.”

Other objects and features will be in part apparent and in part pointed out hereinafter.

### BRIEF DESCRIPTION OF THE DRAWINGS

FIG. 1 is a flow diagram of the process of creating a search term database 116 which reflects terms used by the public to research an issue.

FIG. 2 is a flow diagram of the process that results in the creation of a database, “preliminary container data.” (See 212) This database lists containers that are at least somewhat visible to the public regarding an issue and records the measure of visibility of each container.

FIG. 3 is a flow diagram of the process that results in the creation of a database, “detailed data re containers”, (See 308) which characterizes the most visible containers themselves and the information that constitutes the containers.

FIG. 4 is a first screenshot of a search made on a Keyword Discovery (KWD) Database.

FIG. 5 is a screenshot of a two searches being made on a tow popular search engines.

FIG. 6 is a screenshot of the search results given by a popular search engine.

FIG. 7 is a second screenshot of a search made on a Keyword Discovery (KWD) Database.

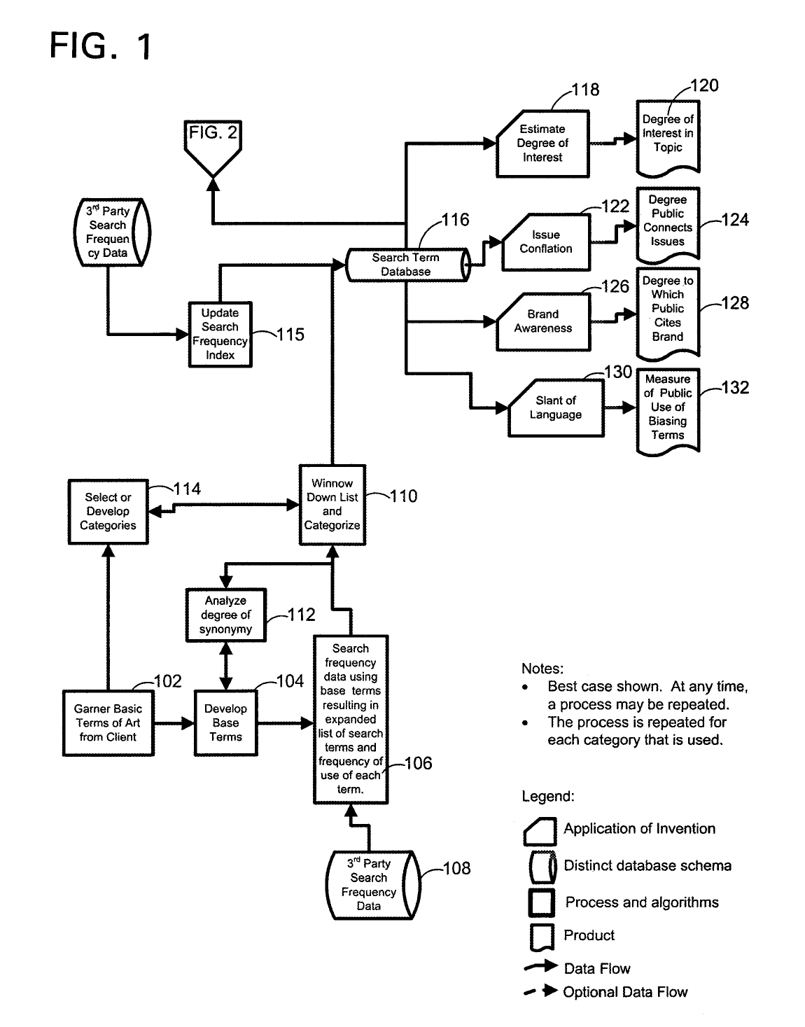

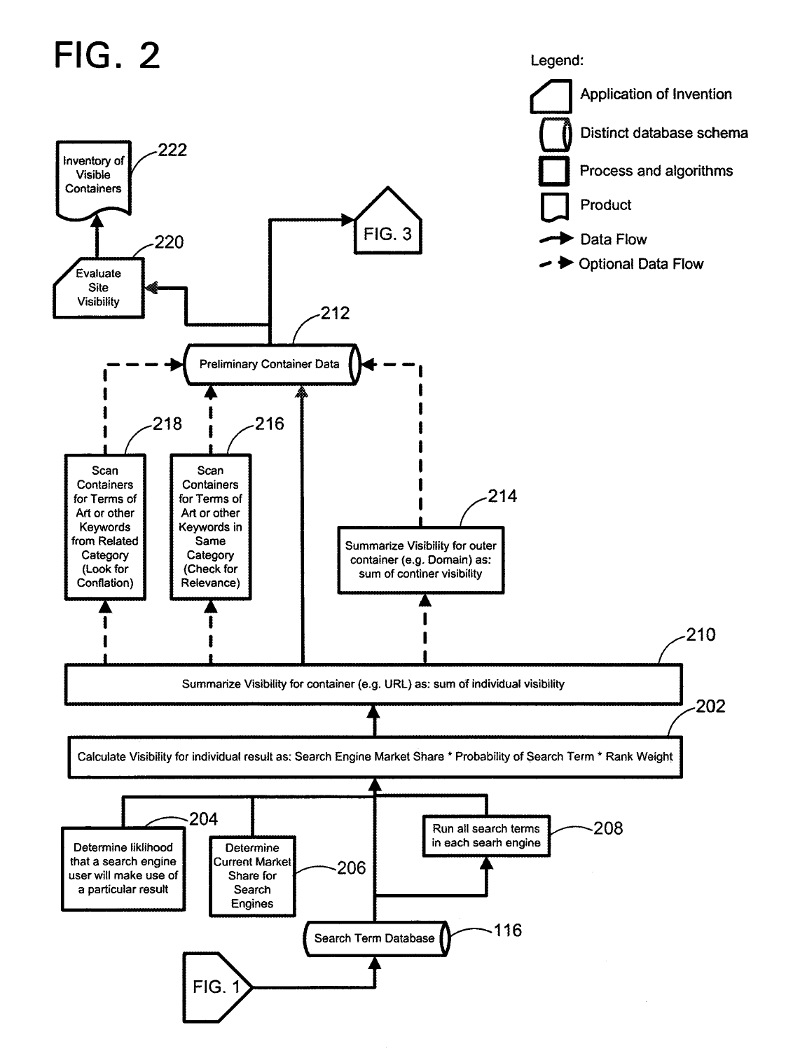

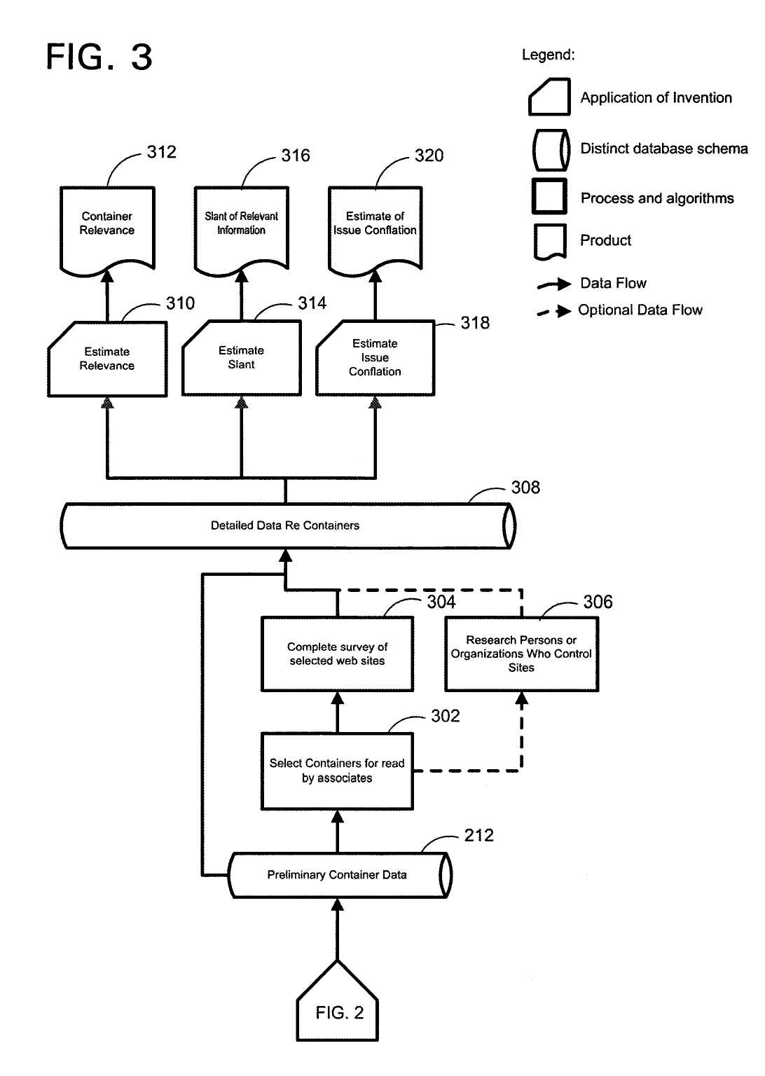

Corresponding reference characters indicate corresponding parts throughout the drawings.

Appendix 1 provides definitions.

### DETAILED DESCRIPTION VISIBILITY

The visibility index, or simply visibility, is a score assigned to websites, web pages, or other Internet information sources collectively called containers, based on the relative frequency of visits by users conducting an Internet search. This relative frequency and the corresponding visibility are expressed within the context of searches within specific but possibly broad areas of interest, denoted categories. Examples of categories include “petroleum”, “pharmaceuticals”, “organic food”, etc.

It is assumed that all individuals will search for information using one of J search engines. At the present time J [symbol] 3, with the search engines being Google, Yahoo, and MSN, represented by the indices j [symbol] 1, 2, 3 respectively. Each search engine j is assigned a relative frequency of use Aⱼ based on publicly available information on market share. If there is only one search engine used, the value of J=1 and Aⱼ=1.

Associated with every category is dictionary of K search terms, indexed by k [symbol] 1 . . . K. These search terms comprise all the words, phrases, or expressions that the public use in research on some topic within the category. The value of K depends on the breadth of the category; for a category as large as “petroleum”, for example, K could be in the thousands. All distinct phrases or combinations of words are treated as different search terms. Each search term is assigned a relative frequency Bₖ based on commercially available information on Internet usage.

An Internet search consists of a pair (j, k). That is, an individual will initiate search with search engine j (with probability Aⱼ) and search term k (with probability Bₖ). It is assumed that the choice of the search engine and search term are independent, so that the probability of searching for term k on engine j is the product AⱼBₖ.

The result of a search is a rank-ordered list of L containers, indexed by l [symbol] 1 . . . L. L can [symbol] 10, the number of search results displayed on one Google page, although L can be any value. This list of containers depends strongly on the search term k, and to a lesser extent on the choice of the search engine j. Each container in the list is assigned an empirically-derived score Cₗ which is based on the probability of an individual clicking on the search result and actually visiting the container. Cₗ is not a relative frequency per se; rather, the sequence Cₗ is a monotonically decreasing function of l beginning with Cₗ [symbol] 1. These values are based on psychological studies of user behavior with search engines and search results. Because the Cₗ are not true relative frequencies, it will be convenient to define

$$C * • {\sum }_{l • 1}^{L} {C}_{l}$$

A search result in this model is an ordered triple (j, k, l), and this search result in turn points to a specific website or container indexed by m. From the above derivation it is clear that the total number of search results is N [symbol] JKL. Define M as the total number of all containers found in all searches within a given category. Because multiple search results will inevitably lead to the same container, we have that M<N. For container m, define the index set I (m) to be the set of all ordered triples (j, k, l) whose corresponding search result is container m.

For each container m, we can now sum over all the search results that lead to that container to arrive at a weighted ranking D(m). This is given by the expression

$$D ( m ) • {\sum }_{( j , k , l ) • I ( m )} {A}_{j} {B}_{k} {C}_{l}$$

This value of D(m) is in effect a measure of how visible or “popular” a given container is. For the purposes of creating a score that may have more intuitive appeal to the end user, the range of D(m) values are mapped into the range 0-100 by means of the simple affine transformation:

$$V ( m ) • \frac{D ( m ) • {min}_{i} D ( i )}{{max}_{i} D ( i ) • min D ( i )} •100$$

The value V(m) (above) is the corrected expression for the visibility of container m.

As noted above, Aⱼ is the probability that a particular search engine will be used. In one embodiment, when this invention is applied in an open environment such as the Internet then this probability Aⱼ is approximated as equal to market share of the search engine. Market share is given by outside sources, for example, at the time of this writing Google has about 50% of market share and so this factor would be 0.5. In one embodiment, when this invention is applied in a closed environment such as a search on a local device such as a laptop then this value is set to 1 to approximate the likelihood of the user selecting a search engine.

As noted above, Bₖ is the probability that a particular search term will be used. This probability is calculated as the number of times a particular search term has been used by the public during a period of time/the total number of times all related search terms were used by the public over the same period. This calculation is subject to the caveats that the data has to be of good quality and non-biasing. It is not necessary to know the actual number of searches because we are using the percent of all uses. That is, it is enough to sample all uses.

In one embodiment, a method for establishing the scope of the denominator, used to calculate Bₖ above (i.e. total number of all searches), is a part of this claim and will form the bulk of the steps described below. The scope of the denominator is the list of all related search terms.

As noted above, Cₗ is an empirically derived factor giving the likelihood that a particular search result will be viewed and/or clicked through. Though these studies are complex and the results are surely approximate, the results confirm what is intuitive: the public is more likely to pay attention to the top results and less likely to pay attention to results deeper into the search results. Periodically, the results of such studies are made available; these 3^{rd} party results may be optionally used in the calculations. This factor may vary by search engine.

Regarding factor Cₗ, based on this research, each identified search result i.e. container (e.g. web page) is assigned a factor. For certain embodiments of the invention, we use a factor of l for the first search result.

As noted above, n is the nth occurrence of a particular container. That is, if a container identified by “xyz.com/kitty” appears five times then the factor (Aⱼ*Bₖ*Cₗ) will be summed across the five occurrences. Please note, that summing across containers that comprise larger containers is implicit in embodiments of the invention. n can refer to a web site as well as a web page so we can apply the invention to calculate the visibility of a web site xyz.com/ by summing the product (Aⱼ*Bₖ*Cₗ) for all instances of that web site.

As noted above, k is a factor in the range 1-infinity that is used to shift the decimal point. In one embodiment, we use k=100 so that the highest value for visibility=100.

Business Process

Step 1

To develop a value for the factor Bₖ, above, the following steps or instructions are employed according to one embodiment of the invention.

In one embodiment, visibility is preferably calculated for an issue. That is, to simply say that a container has n visibility across all queries is not incorrect but would have little practical application. Rather, the usefulness of embodiments of the invention rests in part on the steps described below select only those search terms that relate to an issue. The result is that the method according to embodiments of the invention calculates the visibility of a container for that part of the public with an interest in an issue.

First a set of keywords are determined. These are a collection of search terms that describe the issue or area of interest. We refer to these keywords as “terms of art.” For example, if the area of interest were cholesterol, then we would include in our set of keywords cholesterol certainly but also a wide collection of words that might also lead us to related information such as “bad fat”. The source of these keywords is the entity with subject matter expertise and for whom the research is being performed.

This first set of keywords will contain a subject, the thing about which we are researching. For example, if we are researching Crest toothpaste, the subject would likely be “Crest.”

This first set of keywords will contain a more generic term for the subject. Again, if the subject is Crest then there would be a general term such as “toothpaste.” It is possible to expand to even more general terms such as “oral hygiene” as well.

This first set of keywords may contain competing ideas or products to the subject. If the subject is Crest, then this set may contain “Colgate.”

This first set of keywords may contain terms related to issues bearing on the subject. For toothpaste, we might be concerned with “whitening” and “fluoride.”

Simultaneously, we develop a list of categories. Some categories we have defined as being always present. Categories that are always present include the subject, the general class of the subject, and usually include competition, stakeholders (e.g. the owners of the products). Categories circumscribing critical issues such as health vary by client.

The list of keywords developed to this point is expanded by use of thesaurus so that all synonyms of keywords are included. So for instance a synonym of toothpaste is “dentifrice.”

The list of keywords developed to this point is expanded to include plurals and other common stems such as “toothpastes”.

The list of keywords developed to this point is expanded to include common misspellings and acronyms.

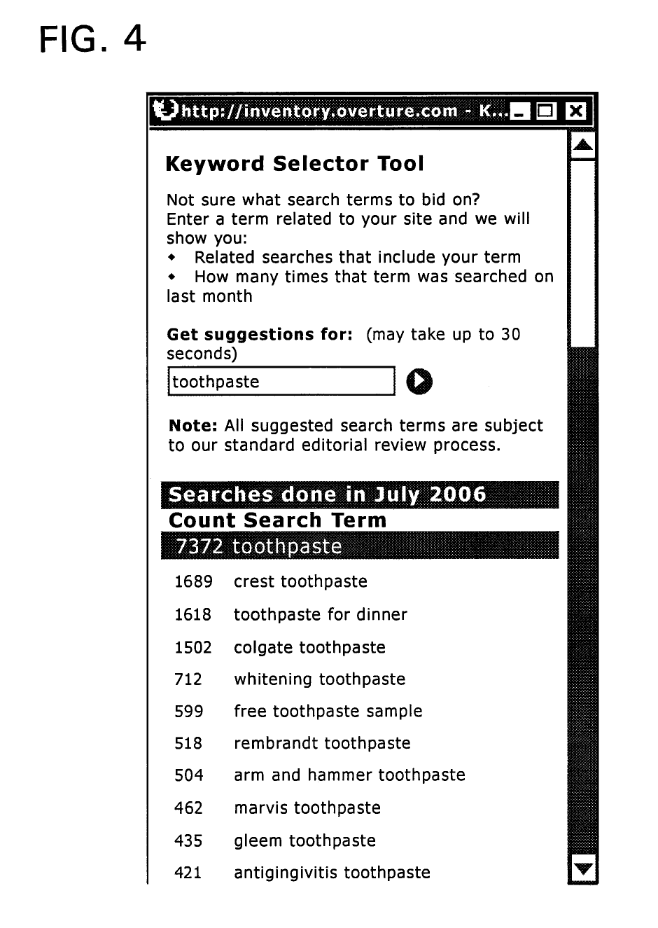

We refer to the list at this stage as our “base terms.” These base terms are then entered into a service that provides the frequency of use of search terms. These frequencies may be updated periodically. An example of such a service would be OVERTURE. An example of data from Overture is provided in FIG. 4. With continuing reference to FIG. 4, all the terms given by this service (“crest toothpaste”, “toothpaste for dinner”) are added to our list of search terms. At this point, our lists commonly include more than 30,000 different terms.

This entire list is evaluated for relevance. An example of a term that might be thrown out is “toothpaste for dinner”; it could be flagged as “irrelevant.” Other reasons for an item to be marked irrelevant are that is too specific as in “crest logo” which indicates someone who is interested in artwork rather than the product itself.

On the other hand some searches are generic such as “enamel”. We have developed two methods for disambiguation of search terms, a quick method and a thorough method. For the sake of explanation, assume we have a search term T that has two possible meanings, T₁ and T₂.

The quick method is based on a reasonable assumption that if a search engine result set for search term T results predominately in containers related to T₁ then the public using search term T is interested in meaning T₁. This assumption is based on the idea that persons interested in meaning T₂ quickly learn not to use term T.

The thorough method involves looking at a series of more detailed queries and allocating interest according to the unambiguous queries. For example, assume we had terms and frequencies as shown in Table 1.

TABLE 1

| Search Term | Frequency of Use by |
|---|---|
| (T) | the Public |
| Oil | 100 |
| 10W40 oil | 10 |
| Flax oil | 20 |
| Safflower oil | 10 |

Given this data we would determine that interest in petroleum products was 10/40 or 25% and ingestible oils was 75%. We could then impute 25% of the 100 searches on oil to the issue of petroleum.

At this point it may be important to determine whether two words are synonymous in the minds of the public using the internet. Two words are synonymous if they can be used interchangeably. For instance, if I am as likely to say “car dealer” as “auto dealer” then we say that car and auto are synonymous. But, I may say “car for conveyor” but never say “auto for conveyor.” So car and auto are often, but not always, synonymous. Our method will measure the degree to which to words are synonymous. To determine the degree of synonymy between keyword A and B, we get the top n search terms for keyword A and the top n search terms for keyword B. In the resulting lists of search terms, we substitute an X for both keywords A & B. As a result of this, there will be in each list an X standing alone, this is discarded. Then we divide the sum the search frequencies of all pairs in the lists by the sum of the search frequencies of both lists to give the degree of synonymy between A & B. For example if we had two sets of search frequency:

TABLE 2

| Term | Frequency |
|---|---|
| TX | 100 |
| TX Drivers License | 50 |
| TX 77098 | 10 |

TABLE 4

| Term | Frequency |
|---|---|
| x | 100 |
| x Drivers License | 50 |
| x 77098 | 10 |
| x | 1000 |
| x Drivers License | 500 |
| x Abbreviation | 20 |

We would transform this to:

TABLE 3

| Term | Frequency |
|---|---|
| Texas | 1000 |
| Texas Drivers License | 500 |
| Texas Abbreviation | 20 |

We discard the row x and the x(s) from each row and sort to yield:

TABLE 5

| Term | Frequency |
|---|---|
| 77098 | 10 |
| Abbreviation | 20 |
| Drivers License | 50 |
| Drivers License | 500 |

The sum of the pair is 550, the overall sum is 580, the degree of synonym is 550/580=0.95.

Note that if A is a synonym of B and B is a synonym of C then it is assumed that A is a synonym of C for our purposes though this empirical approach may yield contrary results.

This entire list of search terms is evaluated to see whether a particular search term should be included in one of the above described categories. Initially, criteria are developed that direct a human (as opposed to an automaton) to determine whether or not to include an item in a category. An example of a criteria would be, “if the search term contains “crest” and does not contain “wave” then it should be included in the subject category.” Ultimately, this is a human decision. Note that a term can be in more than one category.

Special rules apply as search terms are evaluated. If A is a synonym of B then A and B must be both either relevant or irrelevant. Also, A and B must belong to the same categories. That is, you cannot have a situation where A, a synonym of B, is relevant but B is not relevant.

Each term that is added to a category is evaluated to determine whether its search frequency is significant in the context of that category. For example, if the overall frequency of a category is 1M searches, then a term that was used just 100 times will have no impact on the subsequent analysis of that category, i.e. it is insignificant.

A special issue with determining whether a term is significant has been resolved by our invention. Significance depends on the calculation (search frequency of the term in question)/(sum of all search terms in a category). It has been pointed out that you must know the sum of all search frequencies for a category before you can determine whether a search term is significant relative to that category. One approach is to do exactly that; categorize all search terms and then drop those terms that fall below the level of significance. This is improved in our invention by evaluating search terms from most frequent to least frequent. Each search term that is added to a category will increase the denominator and thereby decreasing the significance of all other search terms in the category. Each search term that is evaluated has a decreasing significance; once the threshold of insignificance is passed the analyst can safely stop evaluating search terms for that category because all subsequent search terms will be themselves insignificant. So, any error introduced is an error of including a search term that would not otherwise be included. This type error will not affect the outcome of the procedure. A theoretical special case exists of a term that if included will cause itself to be excluded but if excluded it would seem to be includable. Such a search term is excluded.

Once all the entire list of search terms have been evaluated, then the factor Bₖ can be calculated as: the frequency of search term/the Σ_{1→n}(frequency of search term) where n is the last search term in a given category. Essentially, this factor is the percent a particular search term represents of an entire category.

There are four applications of the invention that are possible after this intermediate step is reached. Three special rules apply: all keywords have to be at the same level of specificity, all synonyms of a keyword must be summed, and all search terms that are more specific than a keyword must be summed.

Estimate degree of interest. It is possible to estimate a degree of interest in a issue by comparing one set of search terms to others in different categories. For example, we can contrast interest in toothpaste with interest in another consumer product such as kitty litter.

Estimate issue conflation. Across categories it is possible to estimate the degree to which two issues are seen to be related. When search terms contain keywords indicating an interest across two categories, then the public is demonstrating a convergence of these ideas. For instance the public will enter search terms such as “mercury fish” but not enter terms such as “red meat cholesterol.” In this case, we estimate that the public is predisposed to conflate mercury with fish but not red meat with cholesterol. To make such a comparison we must first determine the independent frequency of searches on the keywords (fish, mercury, cholesterol, red meat) and related search terms. Designate these frequencies as A,B,C,D. Then the frequency of use of combined terms (mercury fish, red meat cholesterol) and combined related terms is calculated. Designate these frequencies as X,Y. The conflation of mercury with fish is X/(A+B). The conflation of cholesterol with red meat is Y/(C+D).

Estimate brand awareness. Within a category, we can use the search terms to identify the degree of interest in one brand over another. You can, for example, compare interest in Crest to interest in Colgate if in the total for Crest you include search terms such as “Crest toothpaste, buy crest, crest coupon . . . ” As a counter-example, you cannot compare interest in toothpaste to interest in Crest. You can estimate where buyers are on a cycle from interest in a problem, interest in a solution, to interest in a product. This is accomplished by contrasting searches on generic issues such as “oral hygiene” to the sum of interest in specific hygiene products such as toothpaste, flossing, dental cleaning . . . . This analysis can cascade to show the relative interest in toothpaste, flossing, dental cleaning . . . .

Overtime, as issues become more polarized, the language used by opposing stakeholders can become distinct. For example consider the phrases, “right to life” V “choice”. Where polarized language appears, we assign a number between +2 (in line with our client's viewpoint) to −2 (very opposed to our client's viewpoint). The frequency of use of positive and negative search terms is used as a measure of how involved in search one camp or the other is.

STEP 2—OTHER PARAMETERS Search Engines are selected for use in the research. The market share of each search engine is determined. The market share is described above as factor Aⱼ. Market share is determined by 3rd parties and published from time to time.

The likelihood that a particular search result will be viewed and/or acted upon is established. This factor is determined by reference to 3^{rd} party research.

An index is developed for two broad types of search terms: consumer product and other. It has been observed that the volume of search is influenced by the season. In particular, non-consumer product searches fall dramatically in December. This index is based on n search terms that have a relatively stable number of searches when observed month to month. The average of these searches is used as a gauge of general search activity. For example, if searches on Crest are 105% of the number of searches in the previous period; but, the index is at 110% over that same period, then we would understand that the search for Crest was actually down by 5%.

Step 3

Once the entire list of search terms has been evaluated, enter the collection of search terms into one or more search engines. For example, if for the issue “toothpaste” we had determined to use two search terms, “Crest” and “Crest toothpaste” we would enter each in turn into Google, Yahoo, and MSN Live. (See FIG. A.) If it is known that some terms are peculiar to one search engine or another, then those differences are reflected at this step. For example, Google makes use of special parameters such as “define: and more:” resulting that some Google searches will be in the form of “define: toothpaste.” In this case, “define: toothpaste” is entered into Google only.

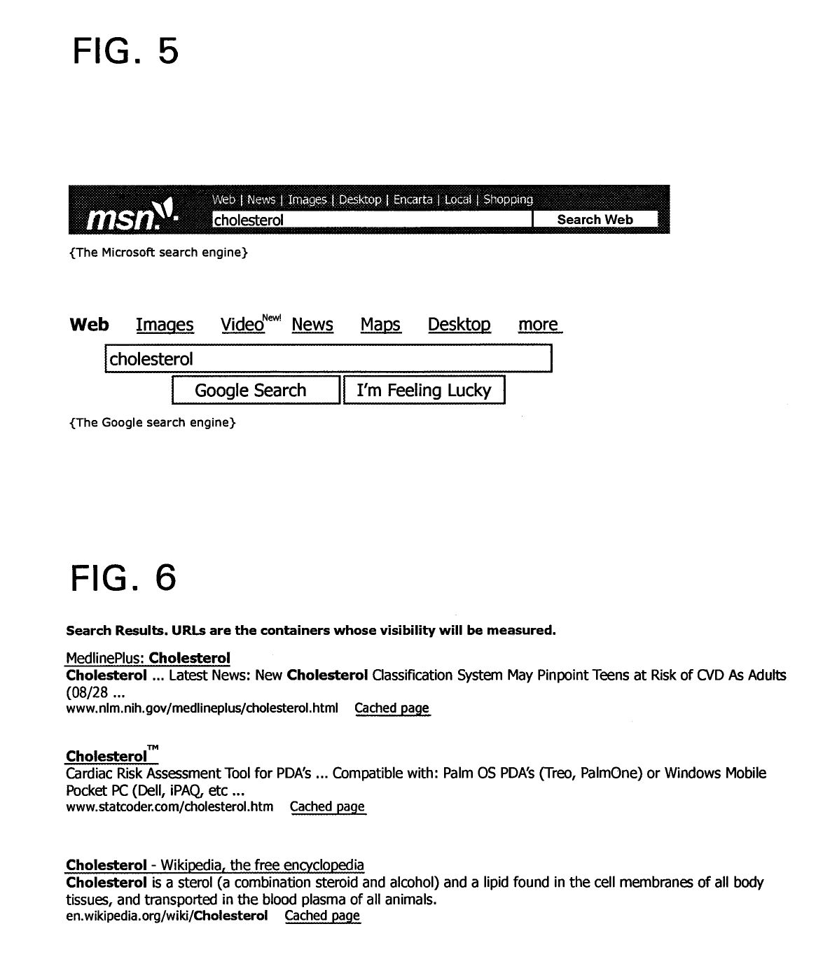

In certain embodiments of the process of the invention, results are segregated based on the categories of search terms developed above. All analysis of results is done using these categories. See FIG. 5.

In certain embodiments of the process of the invention, the search engines are used in a manner consistent with the way the public uses the search engines.

The resulting container, the name of the search engine, the date and time of the search, and the rank of the result are used for the visibility calculation. If an internet search engine is involved, then a web page is the container that will be given a visibility rank. The name of the search engine used determines the market share. The date and time are important as comparisons between search terms should be made over a limited period of time. Finally, the rank is key as it determines the value of Cₗ in the visibility calculation.

Step 4

Once all the search results are captured as described above, it is possible to make the visibility calculation. The visibility calculation was described above. The following describes some alternative applications of the invention.

In certain embodiments of the process of the invention, the containers are scanned for the presence of base words from other categories. Our intention is to determine what the public will see regarding one category if they were to use search terms in a different category. For instance, if the public seeks information regarding cholesterol, are they likely to see information about diabetes? In some cases, only those pages that are found to have the base words, or in some cases not to contain certain keywords, are chosen for survey.

In certain embodiments of the process of the invention, the containers found using terms from one category are first scanned for the presence of base words from that same category. Usually, only those pages that are found to have the base words; or in some cases not to contain certain keywords, are chosen for survey.

Note that in certain embodiments of the process of the invention, further visibility calculations are made on groupings of containers. For example, we can calculate the visibility of a WEB PAGE and the web site to which it belongs.

The most visible containers are selected. Based on these top containers, one or all of the following applications may be made. The number of containers that are chosen depends on standard statistical sampling techniques. Note that the calculation of confidence level and confidence interval is based on a weighted population and sample size. That is, if the most visible url, A, has a visibility of 100, and the second most visible url, B, has a visibility of 80 then these two sites together constitute a population of 180. URL A alone constitutes a sample size of 100 and a sampling percentage of 100/180.

Once containers are evaluated for visibility, an inventory of all discovered containers can be prepared. This inventory is what we refer to as the total visible environment. This inventory is a baseline for future research.

Questionnaires are used to learn more about the containers that have been scored as most visible. The questions that constitute the questionnaire lead to the applications that are described below.

A general note on application of the invention: Results are weighted by the visibility of each container. For example, if a container with a visibility of 100 is favorable, a second container with a visibility of 50 is negative and a third with a visibility of 25 is also negative then we would say that the favorable outweighed the negative by 100 to 75.

The authors, editors, publishers of these containers are researched. The importance of each of these contributors is weighted based on the visibility of the containers they create.

Surveyors are asked to read the material in each of the containers selected in step 3. The material is noted as either relevant to the question or not. In a perfect world, all containers would be relevant since they were found using terms designed to satisfy questions regarding the issue. However, search engines are not perfect. Further, a container may have been found because of it's relevance to category A but may also be relevant in category B. We use this relevance finding to evaluate both the search term and the category. Search terms that do not result in relevant containers may be eliminated. Categories that do not reliably result in relevant containers may indicate a topic that is not easily searched. Relevant search terms and in the aggregate relevant categories are more useful to the public and to our clients.

Surveyors are asked to read the material in each of the containers selected in step 3. The material is assessed for slant as being simply supportive of or biasing against a position. They may make a determination as to whether the material: 1) supports an positive position 2) refutes a positive argument 3) supports a negative argument 4) refutes a negative argument

Estimating issue conflation is done by measuring the relevance of containers of one category that were found by using the search terms of a second category. For example, if I search for information about Mercury in fish, am I likely to find information about the company PetroBras? Or if I were to look for information about diabetes am I going to find information about fructose?

Other

In certain embodiments of the process of the invention, a factor for the likelihood that the public will use a search engine to find containers is used. Examples of other methods of finding containers include: typing a web location into a browser having seen that web location on a business card, using a bookmark, getting a url through an email. Where this application refers to “the likelihood that a particular search result will be seen” it should be understood as related to circumstances in which a person uses a search engine.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the Figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense. Having described the invention in detail, it will be apparent that modifications and variations are possible without departing from the scope of the invention defined in the appended claims.

### APPENDIX 1

### Definitions

Objective—To measure the likelihood that a member of the general public will find information using a keyword search and one or more search engines.

URL—Universal Resource Locator, a character string used as an address where information might be found. URLs identify containers.

Web Site—A collection of information under the control of some legal entity.

Search Term—a string consisting of one or more keywords that may or may not include special characters such as Boolean operators. Search terms are used by the public to find information.

Search Result—The list of containers that are suggested by the search engine as having relevance to the search terms given. See FIG. 6.

Keyword—a string of letters comprising a word. Keywords are essential elements of search terms.

Container—in computer science, a container is a class, a data structure, or an abstract data type whose instances are collections of other objects. They are used to store objects in an organized way following specific access rules. (source:http://en.wikipedia.org/wiki/container_% 28data_structure %29)

For our purposes, a container is any string of text that is locatable by some artifice. For example, a page of a book can be a container; it bounds a string of text and it has a page number by which it can be located. For another example, a web page can be a container; it can be a string of text and has a url by which it can be located. Note that a container can be made up of smaller containers such as is the case of a web site that is made up of web pages.

Issue—a set of facts, beliefs, perceptions around which arguments can develop and opinions can be formed.

Base Term—a simple search term usually suggested by the nature of the issue under consideration. Base terms are expanded upon in order to create the complete list of all search terms. For example, a base term might be ‘toothpaste’ which might lead to other search terms such as ‘good toothpaste’ and ‘buy toothpaste’.

Visibility—The likelihood that a container will be seen by the public. This measure is an attribute of a container. For example, a web page is a container so we will refer to “a web page's visibility.”

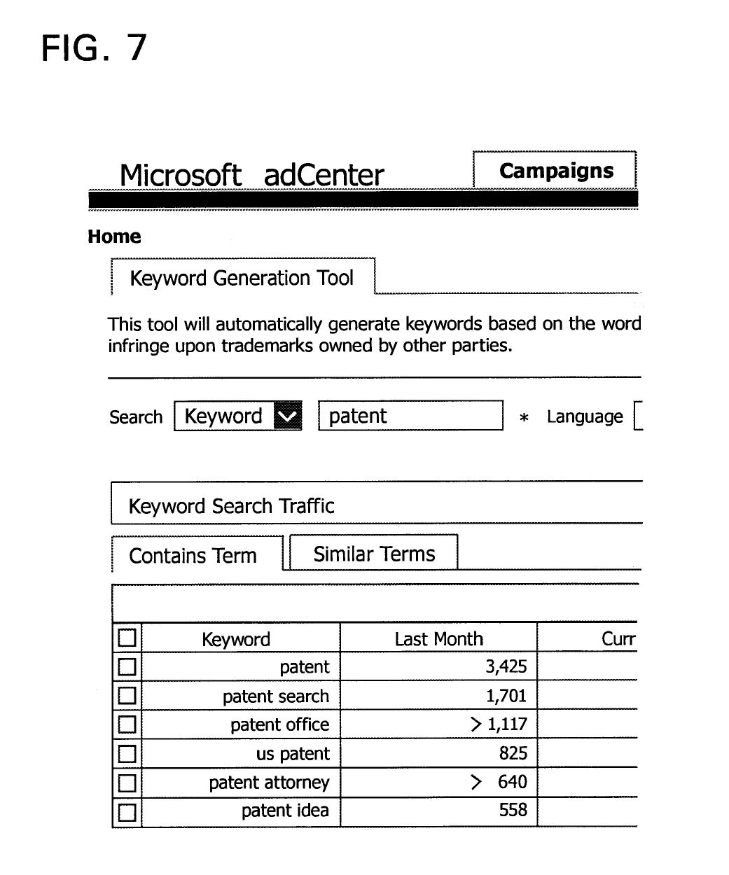

Keyword Discovery (KWD) Database—A class of service informing on the frequency with which the public uses specific search terms. For example, Microsoft currently provides information. See FIG. 7.

From this display, you can see that as of the date of this writing, the ratio of patent attorney to patent office searches is given as 640/1,117.

Search Engine—A computer program whose purpose is accept as input search terms and whose output is a search result.

What is claimed is:

1. A method of ranking information according to the likelihood of its being seen as result of a keyword search on any given issue, said method comprising the following steps or instructions:
developing a collection of search words related to the issue;
measuring the frequency with which any container will be included in search results thereby indicating their visibility; and
ranking each of the identified containers based on their visibility. (The measured frequency of access of the each of the identified web locations relative to the measured frequency of access of the other identified web locations);
whereby the identified web locations having a higher rank over identified web locations having a lower rank have a higher likelihood of being accessed as part of a keyword search related to the issue.

2. The method of claim 1 wherein the step of developing a collection of search terms related to the issue comprises: developing a set of base terms (e.g., 25-50 terms) related to the issue;
searching a keyword discovery (KWD) database for search terms which are a function of the set of base terms, yielding a subset (e.g., 50 k) of the KWD database;
eliminating portions of the subset which are peripherally related to the issue to yield a streamlined subset (e.g., 5 k) of the KWD database;
applying rules to prioritize the streamlined subset to yield the collection of search words related to the issue; and
determining a degree of synonymy of a search term of the subset as compared to another search term of the subset and combining the frequency of access of synonymous search terms.

3. The method of claim 2 wherein analysis of portions of the subset comprises at least one of the following: determining a degree of public interest of a search term of the subset;
determining a brand awareness of a search term of the subset;
determining issue conflation of a search term of the subset;
determining a slant of a search term of the subset.

4. The method of claim 1 wherein prioritizing comprises: Determining information that is most likely to be seen by the public regarding the issue; and
characterizing the determined information that is most likely to be seen by the public regarding the issue.

5. The method of claim 4 wherein determining comprises at least one of:
determining preliminary container data;
evaluating visibility of the preliminary container data; and
defining an inventory of visible containers from the evaluated visibility.

6. The method of claim 4 wherein characterizing comprises at least one of:
determining a relevance of the detailed data;
determining a slant of the detailed data; and
determining issue conflation of the detailed data.
